(19) United States
(12) Patent Application Publication
(10) Pub. No.: US 2025/0128268 A1
(43) Pub. Date: Apr. 24, 2025

(54) APPARATUS FOR REMOVING MAGNETICALLY ATTRACTED MATERIALS

(71) Applicants: Adam Michael Arnold, Riverside, MO (US); Jason R. Dake, Riverside, MO (US)

(72) Inventors: Adam Michael Arnold, Riverside, MO (US); Jason R. Dake, Riverside, MO (US)

(21) Appl. No.: 18/490,099

(22) Filed: Oct. 19, 2023

(51) Int. Cl. B03C 1/033; H01F 7/02

(52) U.S. Cl. CPC B03C 1/033; H01F 7/02; B03C 2201/20

(57) ABSTRACT

An apparatus to clear magnetically attracted materials from select locations is disclosed. Embodiments include a housing within which a magnetic body and a mechanism are contained. The mechanism is powered and sized for moving the magnetic body between a first position where magnetically attracted material (initially attracted to but thereafter) adhering to an exterior surface portion of the housing, and a second position where the magnetically attracted material, no longer attracted, falls from exterior surfaces by gravity.

### REFERENCE TO RELATED APPLICATION

The present nonprovisional patent application is based on U.S. provisional patent application Ser. No. 63/362,609 filed Apr. 7, 2022, hereby incorporated by reference in its entirety, for priority purposes pursuant to Title 35, United States Code, Sections 111, 120.

### FIELD

The present subject matter is generally directed to clearing areas of scrap metal and more particularly, to removing magnetically attracted metal scraps from select areas.

### BACKGROUND

Most junk yards, many trash-dumps of villages and cities, and an assortment of industrial areas are often littered with various scraps, large and small, including shards, many of which often have sharp edge margins, of assorted magnetically attracted metals.

Materials attracted to a magnet are known. Such materials include “ferromagnetic” (or ferrimagnetic) materials, e.g., iron, nickel, cobalt, and their alloys, certain rare-earth metals, and certain naturally occurring minerals, e.g., lodestone. Although ferromagnetic (or ferrimagnetic) materials are the only materials attracted to a magnet strongly enough to be considered truly magnetically attracted materials, certain other materials do respond to a magnetic field—albeit only weakly—by one or several, other “types” of magnetism.

Devices to attract such materials to a magnet are known. For instance, U.S. Pat. No. 2,693,279 to Box et al. discloses a magnetic floor sweeper having a cylindrical drum, an outer surface of which serves as a collecting surface, a magnetic body located within the drum, and wheels for enabling the drum to be moved over a surface from which material, collected by the magnetic body, is to be collected. U.S. Pat. No. 2,760,809 to Mallin discloses a tool having a cavity within which a magnetic body is adapted to be reciprocally moved.

U.S. Pat. No. 3,487,939 to Keeley discloses an apparatus to separate ferromagnetic material from a mixture. The apparatus includes a continuous belt having a first position located adjacent to a magnetic field, a second position remote from the magnetic field, and a third position located adjacent to an auxiliary magnet field. Ferromagnetic material, brought to the first position, adheres to the belt, is carried by the belt through the second position, and is removed from the belt at the third position by the auxiliary magnetic field.

U.S. Pat. No. 6,113,169 to Gohman et al. discloses a magnetic device for picking up ferrous metal debris, including nails, screws, sheet metal fragments, staples, rivets, and other ferrous metal objects from an environmental surface such as the ground or a floor by rolling along the surface. The magnetic device includes a magnetic pickup member, a pair of wheels mounted to the pickup member for supporting the pickup member above a surface. The magnetic device also includes a handle, a wiper to scrape ferrous metal debris from the pickup member, and a release rope to rotate the magnetic pickup member against the wiper, for separating ferrous metal debris from the magnetic pickup member.

U.S. Pat. No. 6,402,212 to Hsiao discloses a magnetic sweeper including a mounting frame with opposed (left and right) side walls, a rotating shaft with ends journalled in the left and right-side walls, and a cylindrical body around the shaft. A plurality of permanent magnets, disposed within a circumferential wall of the cylindrical body, define uppermost and lowermost magnetic linear limits. A guiding member (formed of nonmagnetic material secured to the left and right-side walls) includes a major wall with leading and tailing ends respectively spaced non-equidistantly from the uppermost and lowermost magnetic linear limits. A collecting member is disposed downstream of (and also below) the uppermost magnetic linear limit for receiving magnetic metal objects captured by means of the permanent magnets. A mounting axle, disposed on the mounting frame, is spaced apart from the rotating shaft to mount a wheel member. A coupling member, to transmit rolling movement of the wheel member to the rotating shaft, is used to rotate the cylindrical body.

U.S. Pat. No. 8,196,751 to Shuttleworth et al. discloses a permanent magnet drum separator for removal of a ferrous fraction from a material stream. The drum separator includes a pickup magnet, provided by a rare earth permanent magnet movable within the drum separator. The drum separator includes a rotatable outer shell having a tubular shape and a circular cross section. The drum separator includes a carry magnet positioned at a fixed location within the outer shell adjacent to the inside circumference of the outer shell. The pickup magnet is positioned on a hinge plate (within the outer shell) having a first end attached to a hinge and a second end attached to a movable body. The hinge is positioned at a fixed location in the outer shell near the inside circumference of the outer shell. The movable element moves the pickup magnet about the hinge to vary the distance between the pickup magnet and the inside circumference of the outer shell.

U.S. Pat. No. 8,641,112 to Anderson discloses a device including a reservoir to collect metallic debris, a hollow housing containing a permanent magnet, and a mechanism to raise and lower the magnet. When the magnet is lowered to a predetermined position, its magnetic field extends beyond the reservoir, for causing magnetically attracted metallic debris to adhere to reservoir surface portions. To remove metallic debris thus attracted magnetically, the mechanism raises the magnet to a position beyond the magnetic field.

US publication 2007/0084759 to Shiao discloses a magnetic sweeper including a housing, a handle unit, and a magnetic attracting seat unit. The housing includes an annular wall and a stop plate projecting from an outer surface of the annular wall. The handle unit is fixedly connected to the housing. The magnetic attracting seat unit includes a rotating shaft member disposed coaxially and rotatably within the annular wall and having a magnet mounting portion and a plurality of housing-retaining portions in frictional contact with an inner surface of the annular wall, to maintain positioning of the rotating shaft member within the housing. A plurality of magnetic attracting members is disposed fixedly on the magnet-mounting portion. The plural members are arranged along an axial direction of the rotating shaft member. At least one rotary member is connected fixedly to the rotating shaft member and is disposed outwardly of the housing for manual operation.

US publication 2021/0087763 to Orbell et al. discloses an apparatus having a magnetic source able to attract ferromagnetic material along with absorbed unwanted material when the magnetic source is within an area of operation. The apparatus includes a mechanism to dislodge ferromagnetic material and absorbed unwanted material from the apparatus after ferromagnetic material has been removed from the area of operation.

As a person of ordinary skill in the art (“POSITA”) can appreciate, prior art devices and mechanism in the field of the present subject matter can be complex in design and/or cumbersome to operate, suggesting a simpler design and mode-of-operation is needed.

### SUMMARY

The present subject matter, an apparatus to clear magnetically attracted materials from select locations (such as junk yards, industrial areas, and manufacturing facilities) includes a housing in which a magnetic body and a mechanism adapted and configured to move the magnetic body between a first position and a second position are contained.

When the magnetic body is located at the first position, the body causes material magnetically attracted to it to adhere to an exterior surface of the housing; and when the body is moved to the second position, the material falls from the housing exterior surface.

The housing includes a lift ring, to which a load-lifting portion of a wheeled vehicle can be connected by a user, for transporting the apparatus from one location to another.

### BRIEF DESCRIPTION OF THE FIGURES

FIG. 1 is an isometric view of an end portion of a segment of an embodiment of an apparatus for removing magnetic materials in accordance with the present subject matter.

FIGS. 2, 3 present end views of the embodiment shown in FIG. 1, in which FIG. 2 shows a magnetic body at a first position and FIG. 3 shows the body at a second position.

FIGS. 4 and 5 present end views of another present embodiment, in which FIG. 4 shows a magnetic body at a first position and FIG. 5 shows the body at a second position.

FIG. 6 shows the magnetic field lines-of-force for a magnetic body of embodiments.

Throughout the figures—and the detailed description which follows—I shall use similar reference numerals, to refer to similar components of the present subject matter.

### DETAILED DESCRIPTION

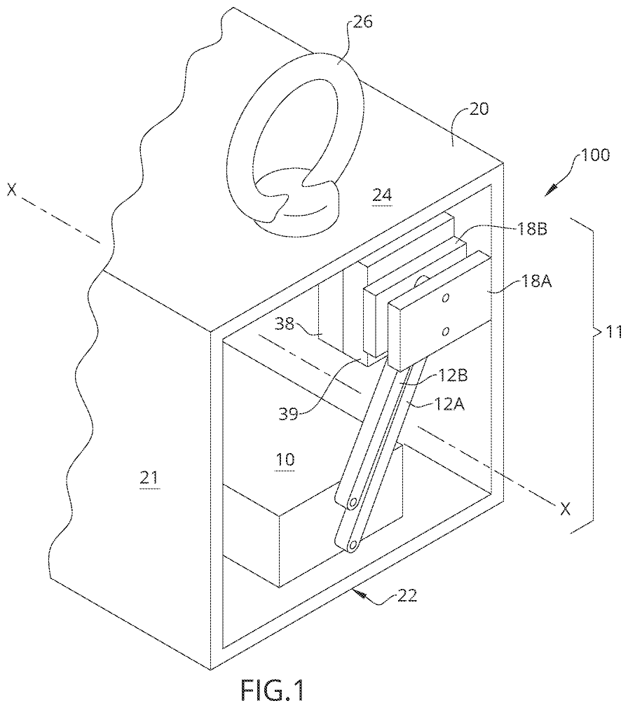

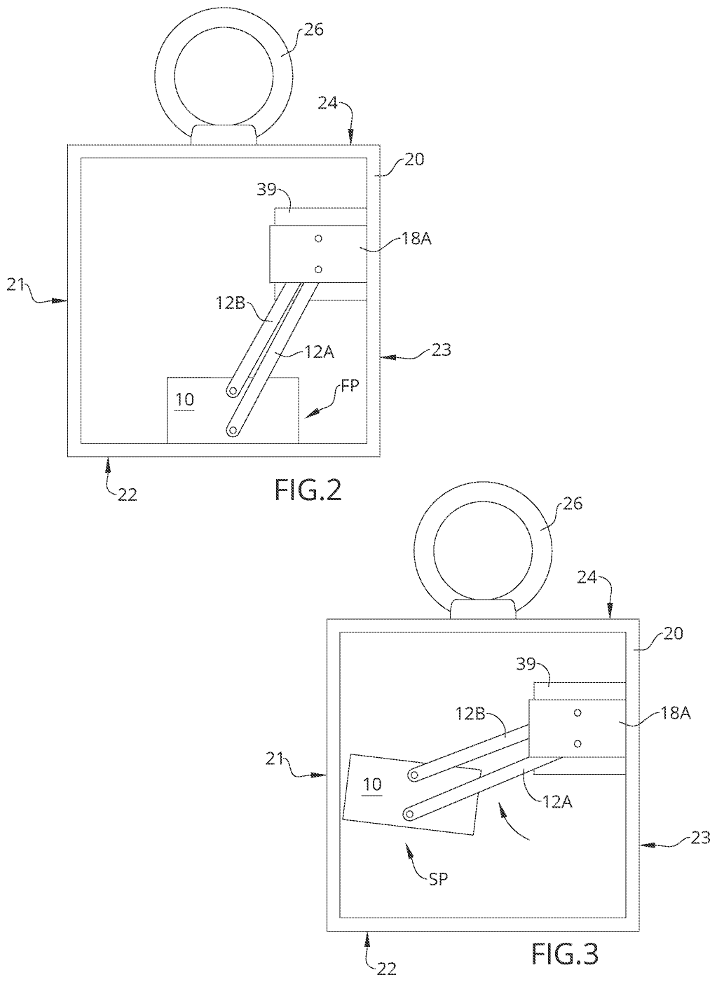

Referring initially to FIGS. 1-3—one embodiment of the present subject matter—an apparatus 100 for removing magnetically attracted materials from select locations (junk yards, industrial areas, manufacturing facilities, etc.), will now be described in detail.

The apparatus 100 includes a housing 20, at least one lifting device 26 fixed to the housing 20, a magnetic body 10 within the housing 20, a mechanism 11 within the housing 20, a power source 38 within the housing 20, and a motor 39 fixed within the housing 20.

The mechanism 11 is sized, adapted, and configured for moving the magnetic body 10 between a first position FP and a second position SP spaced from the first position FP.

Power source 38 (FIG. 1) is operatively connected to the motor 39 which, in turn, is operatively connected to the mechanism 11, for enabling the mechanism 11 to be used for moving the magnetic body 10 between the first and the second positions FP and SP.

Apparatus 100 to remove magnetically attracted materials from areas includes at least one lift ring 26 fixed to a housing upper surface. Housing 20, shown longitudinally disposed about an axis X-X in FIG. 1, can be any length necessary to clear such areas as junk yards, industrial areas, and manufacturing facilities of a variety of magnetically attracted materials. Wheeled vehicles with load-lifting mechanisms (not shown) could be used to move the apparatus for clearing magnetically attracted materials from such areas.

While housing 20 has four sides—21, 22, 23, and 24, with each of the four sides orthogonally oriented relative to each of the two sides adjacently connected thereto—a person of ordinary skill in the art (“POSITA”) is aware that housings can have plural sides.

For apparatus 100, mechanism 11 includes at least one plate 18a fixed to an inner surface portion of housing 20 and at least one elongated member 12a having opposite end portions. One end portion of elongated member 12a is pivotally connected to plate 18a. An opposite end portion of elongated member 12a is pivotally connected to magnetic body 10. Mechanism 11 also includes at least one additional plate 18b fixed to an inner surface portion of housing 20 in spaced relation to the first-described plate 18a and further includes at least one additional elongated member 12b having opposite end portions. The one end portion of the first-described elongated member 12a is pivotally connected to the additional plate 18b. One end portion of additional elongated member 12b is pivotally connected to the first-described plate 18a and to the additional plate 18b. The opposite end portion of the additional elongated member 12b is pivotally connected to the magnetic body 10. Both elongated members 12a, 12b are spaced between the two plates 18a, 18b.

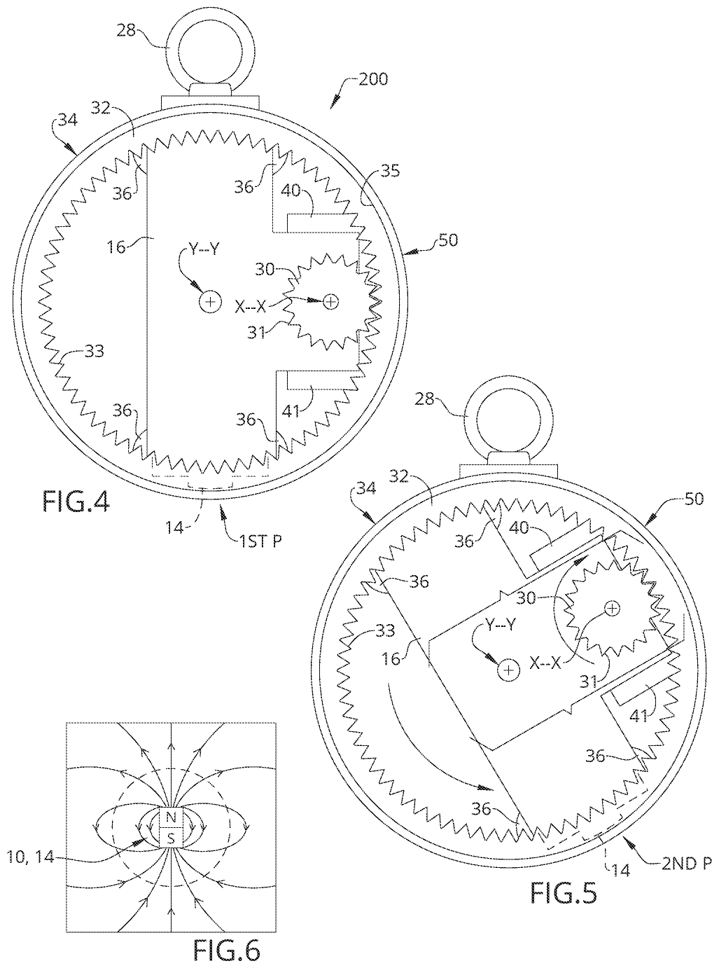

Referring next to FIGS. 4, 5—another embodiment of the present subject matter—an apparatus 200 for removing magnetically attracted materials from select locations (junk yards, industrial areas, manufacturing facilities, etc.), will now be described in detail.

Apparatus 200 includes a housing 34 having an interior surface 35, a magnetic body 14 disposed in the housing 34 adjacent to the interior surface 35, and a mechanism 50 arranged within the housing 34. Also arranged within the housing 34 are a power source 40 and a motor 41. The mechanism 50 is sized, adapted, and configured for moving the magnetic body 14 between a first position 1stP and a second position 2ndP spaced from the first position 1stP. Power source 40 is operatively connected to motor 41 which, in turn, is operatively connected to mechanism 50, for enabling mechanism 50 to controllably move magnetic body 14 between the first and second positions 1stP, 2ndP.

The embodiment of housing 34 (depicted as circular in cross section in FIGS. 4, 5) is cylindrical and has at least one lift ring 28 fixed to an upper surface portion thereof.

For apparatus 200, mechanism 50 includes a plate 16 oriented within housing 34 and rotatable about a first axis Y-Y. Mechanism 50 includes first and second gears 32, 30. The first gear 32 is oriented within housing 34 about the first axis Y-Y. The first gear 32, depicted as an annular ring secured (permanently or temporarily) to the interior surface 35 of housing 34, includes a plurality of radially inwardly oriented gear-teeth 33. Second gear 30, also oriented within housing 34, is rotatable about a second axis Z-Z spaced from the first axis Y-Y and has a plurality of radially outwardly oriented gear-teeth 31 that mesh with the radially inwardly disposed gear-teeth 33 of the first gear 32.

Apparatus 200 of this embodiment of the present subject matter includes a plurality of wheels 36 oriented about first axis Y-Y and rotatably mounted on plate 16 to provide rolling engagement of the plural wheels 16 along interior surfaces 35 of the housing 34.

For apparatus 200, rotation of the second gear 30 about the second axis Z-Z (when caused by operation of motor 41 by a user of apparatus 200) causes the second axis Z-Z to be rotated clockwise and/or counterclockwise about the first axis Y-Y for moving magnetic body 14 between the first position 1stP and the second position 2ndP.

For embodiments resembling FIGS. 4, 5 a POSITA would know of these gear sets.

An epicyclic gear train (also known as a planetary gearset) consists of two gears mounted so that the center of one gear revolves around the center of the other. A carrier connects the centers of the two gears, rotating meshing planet and sun gears so that their pitch circles roll without slippage. A point on a pitch circle of the planet gear traces an epicycloid curve. In this simplified case, the sun gear is fixed, and the planetary gear(s) roll about the sun gear. An epicyclic gear train can be assembled so that a planet gear rolls on an inside surface of a pitch circle of a fixed, outer ring gear, sometimes called an annular gear. In this case, the curve traced by a point on the pitch circle of the planet is a hypocycloid. The combination of epicycle gear trains with a planet engaging both a sun gear and a ring gear is often called a planetary gear train. In this case, the ring gear is usually fixed, and the sun gear driven. Epicyclic gearing (or planetary gearing) is a gear system consisting of one or more outer, or planet gears (or pinions), revolving about a central sun gear (or sun wheel). Typically, planet gears are mounted on a movable arm or carrier, which itself may rotate relative to the sun gear. Epicyclic gearing systems also incorporate a use of an outer ring gear (or annulus), which meshes with the planet gears. Planetary gears (or epicyclic gears) are typically classified as simple or compound planetary gears. Simple planetary gears have one sun, one ring, one carrier, and one planet set. Compound planetary gears involve one or more of the following three types of structures: meshed-planet (there are at least two more planets in mesh with each other in each planet train), stepped-planet (there exists a shaft connection between two planets in each planet train), and multi-stage structures (the system often contains two or more planet sets). Compared to simple planetary gears, “compound” planetary gears provide an advantage of larger reduction ratio, higher torque-to-weight ratio, and more flexible configurations. Moreover, the axes of all gears are usually parallel, except for special cases, e.g., pencil sharpeners and differentials, often oriented at an angle, to introduce elements of a bevel gear. Finally, the sun, planet carrier, and ring axes are usually coaxial.

Magnetic fields describe magnetic influence on magnetically attracted materials. Magnetic fields, which attract ferromagnetic materials, will always attract or repel other magnets. Nonuniform magnetic fields exert lesser forces on “nonmagnetic” materials by such effects as: paramagnetism, diamagnetism, and antiferromagnetism. Furthermore, magnetic fields from ferromagnetic materials arise when electric currents are caused to flow around such ferromagnetic materials, such as occurs when electromagnets are used.

Illustrated and described in detail throughout this patent specification are two embodiments of an apparatus for removing magnetically attracted materials. While the present subject matter has been described with reference to exemplary embodiments, the present subject matter is not limited to them. On the contrary, alternatives, changes, and modifications shall become apparent to a person of ordinary skill in the art (“POSITA”) this specification and accompanying drawing figures are reviewed. Therefore, all such alternatives, changes, and modifications are to be treated as forming part of the present subject matter insofar as they fall within the spirit and the scope of the appended claims.

1. An apparatus (100) for removing magnetically attracted materials from an area, comprising:
a housing (20);
a magnetic body (10) disposed in the housing (20);
a mechanism (11) disposed in the housing (20), wherein the mechanism (11) is sized, adapted, and configured for moving the magnetic body (10) between a first position (FP) and a second position (SP) spaced from the first position (FP);
a power source (38) disposed in the housing (20); and
a motor (39) disposed in the housing (20) and operatively connecting the power source (38) and the mechanism (11) for enabling the mechanism (11) to be used to move the magnetic body (10) between the first and second positions (FP, SP).

2. The apparatus of claim 1, for removing magnetically attracted materials from an area, including at least one lift ring (26) fixed to an upper surface portion of the housing.

3. The apparatus (100) of claim 1, for removing magnetically attracted materials from an area, wherein the housing (20) is longitudinally disposed about an axis (X-X).

4. The apparatus (100) of claim 3, wherein the housing (20) has a plurality of sides.

5. The apparatus (100) of claim 3, for removing magnetically attracted materials from an area, wherein the housing (20) has at least four sides (21, 22, 23, and 24).

6. The apparatus (100) of claim 5, wherein each of the four sides (21, 22, 23, 24) is orthogonally disposed relative to each of the two sides adjacently connected thereto.

7. The apparatus (100) of claim 1, for removing magnetically attracted materials from an area, wherein the mechanism (11) comprises:
at least one plate (18a) fixed to an inner surface portion of the housing (20); and
at least one elongated member (12a) having opposite end portions, wherein one end portion of the at least one elongated member (12a) is pivotally connected to the at least one plate (18a), and wherein the opposite end portion of the at least one elongated member (12a) is pivotally connected to the magnetic body (10).

8. The apparatus (100) of claim 7, for removing magnetically attracted materials from an area, wherein the mechanism (11) includes:
at least one additional plate (18b) fixed to an inner surface portion of the housing (20) in spaced relation to the at least one plate (18a), wherein the one end portion of the elongated member (12a) is pivotally connected to the at least one additional plate (18b); and
at least one additional elongated member (12b) having opposite end portions, wherein one end portion of the at least one additional elongated member (12b) is pivotally connected to the at least one plate (18a) and to the at least one additional plate (18b), wherein the opposite end portion of the at least one additional elongated member (12b) is pivotally connected to the magnetic body.

9. The apparatus (100) of claim 8, wherein the at least one elongated member (12a) and the at least one additional elongated member (12b) are spaced between the at least one plate (18a) and the at least one additional plate (18b).

10. An apparatus (200) for removing magnetically attracted materials from an area, comprising:
a housing (34) defining an interior surface (35);
a magnetic body (14) disposed in the housing (34) adjacent the interior surface (35);
a mechanism (50) disposed in the housing (34), wherein the mechanism (50) is sized, adapted, and configured for moving the magnetic body (14) between a first position (1stP) and a second position (2ndP) spaced from the first position (1stP);
a power source (40) disposed in the housing (34); and
a motor (41) disposed in the housing (34) and operatively connecting the power source (40) and the mechanism (50), for enabling the mechanism (50) to move the magnetic body (14) between the first and the second positions (1stP, 2ndP).

11. The apparatus (200) of claim 10, for removing magnetically attracted materials from an area, wherein the housing (34) is cylindrical.

12. The apparatus (200) of claim 11, for removing magnetically attracted materials from an area, wherein the mechanism (50) comprises:
a plate (16) disposed within the housing (34) and rotatable about a first axis (Y-Y);
a first gear (32) disposed within the housing (34) about the first axis (Y-Y), wherein the first gear (32) is secured to the interior surface (35) of the housing (34), and wherein the first gear (32) has a plurality of radially inwardly disposed teeth (33);
a second gear (30) disposed within the housing (34), wherein the second gear (30) is rotatable about a second axis (Z-Z) spaced from the first axis (Y-Y), and
wherein the second gear (30) has a plurality of radially outwardly disposed teeth (31) that mesh with the radially inwardly disposed teeth (33) of the first gear (32).

13. The apparatus of claim 10, for removing magnetically attracted materials from an area, including at least one lift ring (28) fixed to an upper surface portion of the housing.

14. The apparatus (200) of claim 12, for removing magnetically attracted materials from an area, wherein the apparatus (200) includes:
a plurality of wheels (36) rotatably mounted on the plate (16) for providing rolling engagement of the plurality of wheels (16) along the interior surface (35),
whereby rotation of the second gear (30) about the second axis (Z-Z) causes the second axis (Z-Z) to be rotated clockwise and/or counterclockwise about the first axis (Y-Y) for moving the magnetic body (14) between the first position (1stP) and the second position (2ndP).
